(19) United States
(12) Patent Application Publication
(10) Pub. No.: US 2005/0007773 A1
(43) Pub. Date: Jan. 13, 2005

(54) Novelty bottle

(76) Inventor: James Austin, Hammonton, NJ (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 10/616,664

(22) Filed: Jul. 10, 2003

(51) Int. Cl. F21V 33/00

(52) U.S. Cl. 362/206

(57) ABSTRACT

A novelty bottle which includes an enclosed container made of transparent material, optimally yellow in color. The top of the container is capped with a screw type switch which, when rotated, turns on a light source within the container. The light source is powered by a flat circular battery.

### BACKGROUND OF THE INVENTION

Novelty items which are representative of specific geographical areas, especially vacation, resort, and other tourist oriented attractions, are very popular, both as marketing products for these sites and as pleasant reminders to those who have visited them. Such items are also very popular as gifts, which are brought back to family and friends. Examples of these types of novelty items include things unique to a given locale, such as a flask of sand from a desert, a particular rock unique to a mountainous area, ash from a volcano, etc. Such items are routinely combined with key chains, refrigerator magnets and the like. Clever and imaginative novelty items have great appeal to visitors as gifts and keepsakes.

### SUMMARY OF THE INVENTION

It is thus an object of the present invention to provide a novelty item which is clever, imaginative, and unique.

It is another object of the present invention to provide a novelty bottle which will appeal as a gift, keepsake, or token, representing a visit to a warm weather climate.

It is a further object of the present invention to provide a novelty bottle which will simulate the capture and enclosure of the natural light represented by the sun, indicative of warm weather locales.

It is still another object of the present invention to provide a novelty bottle which includes a light source within a container which will represent a “bottle of sunshine” from warm weather locales.

These and other objects are accomplished by the novelty bottle of the present invention which includes an enclosed container made of transparent material, optimally yellow in color. The top of the container is capped with a screw type switch which, when rotated, turns on a light source within the container. The light source is powered by a flat circular battery.

The novel features which are considered as characteristic of the invention are set forth in particular in the appended claims. However, both as to their design, construction, and use, together with additional features and advantages thereof, they are best understood upon review of the following detailed description with reference to the accompanying drawings.

### BRIEF DESCRIPTION OF THE DRAWINGS

FIG. 1 is a front view of the novelty bottle from the present invention.

FIG. 2 is a front view of the novelty bottle of the present invention in combination with a key chain.

FIG. 3 is a view of the novelty bottle of the present invention in combination with a refrigerator magnet.

### DETAILED DESCRIPTION OF THE INVENTION

Novelty bottle 1 comprises a container 2 housing a light source, e.g. light emitting diode 3 (LED). Power is supplied to the light source from flat circular battery 4. Switch 5 constitutes a common screw activated type switch which, when rotated and turned to the on position, causes LED 3 to become lit within enclosed container 2.

Container 2 is optimally formed of transparent plastic material, yellow in color. When switch 5 is turned on lighting LED 3 within container 2, container 2 provides the appearance of having encapsulated and captured enclosed natural light from the sun.

It is contemplated that label 6 will be adhered to container 2 and will read “A Bottle of Sunshine from Florida” or similar warm weather locale.

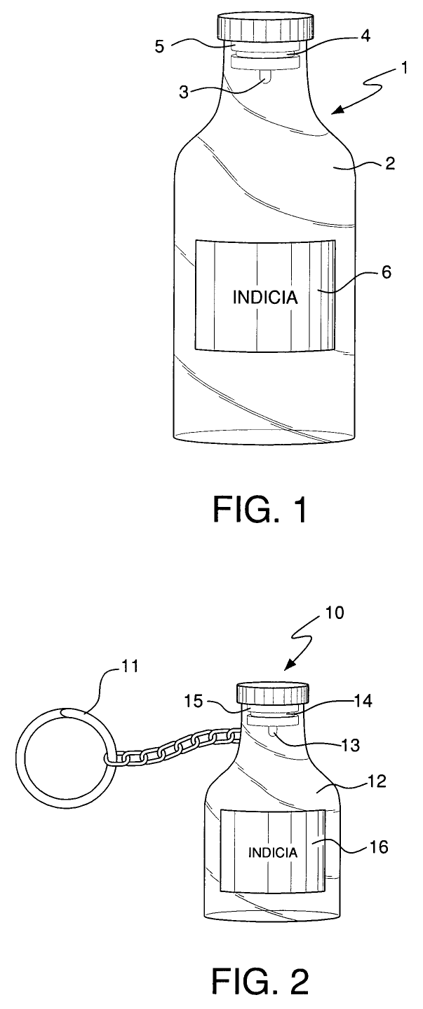

FIG. 2 shows key chain 11 attached by cement or other common means to container 12 of bottle 10, which is smaller than bottle 1. LED light source 13, battery 14, and screw activated switch 15 are identical to that which is described in the embodiment shown in FIG. 1. Label 16 is adhered to container 12.

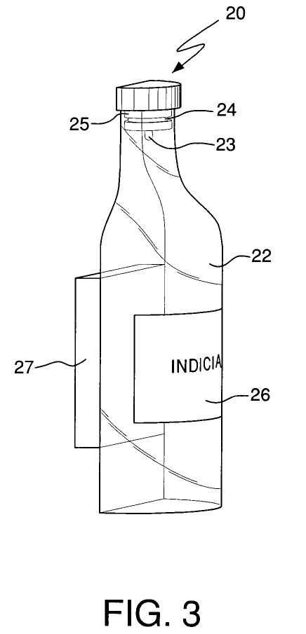

FIG. 3 shows an embodiment of the invention used as a refrigerator magnet, including bottle 20 with container 22, LED light source 23, battery 24, screw activated switch 25 and label 26 adhered to container 22. Magnet 27 is again attached to container 22 by cement or other commonly known means.

The novelty bottle of the present invention, as described, is a unique and imaginative item, representing and simulating the capture and enclosure of natural light from the sun from a warm weather locale. It is envisioned that the present invention will find favor and be popular with visitors and tourists, as a reminder and keepsake of the sunny and warm nature of the environments they visited and as gifts to family and friends upon their return.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A novelty bottle for use in simulating the capture and enclosure of natural light, said bottle comprising:
(a) an enclosed container formed of transparent material;
(b) a light source supported within the container;
(c) means within the container for suppling electrical power to the light source;
(d) switch means located on the container for actuating the light source, whereby upon activation of the switch means, the light source is lit within the container, simulating captured natural light enclosed within the container.

2. The novelty bottle as in claim 1 wherein the light source is a light emitting diode.

3. The novelty bottle as in claim 1 wherein the means for suppling electrical power comprises a battery pack located between the switch means and the light source.

4. The novelty bottle as in claim 1 wherein the switch means comprises a screw activated switch.

5. The novelty bottle as in claim 1 wherein the switch means comprises a screw activated switch and the means for suppling electrical power comprises a battery, whereby upon turning of the screw activated switch, power flows from the battery pack to the light source within the container, simulating captured natural light enclosed within the container.

6. The novelty bottle as in claim 1 further including a key chain secured to the container.

7. The novelty bottle as in claim 1 further comprising a magnet attached to the container.
